(19) United States
(12) Patent Application Publication
(10) Pub. No.: US 2007/0061287 A1
(43) Pub. Date: Mar. 15, 2007

(54) Method, apparatus and program storage device for optimizing a data warehouse model and operation

(76) Inventors: Jian Le, San Mateo, CA (US); Daniel Martin Dekimpe, La Selva Beach, CA (US)

Correspondence Address: DAVID W. LYNCH;CHAMBLISS, BAHNER & STOPHEL, 1000 TALLAN SQUARE-V, TWO UNION SQUARE, CHATTANOOGA, TN, 37402, US

(21) Appl. No.: 11/222,627

(22) Filed: Sep. 9, 2005

(51) Int. Cl. G06F 17/30

(52) U.S. Cl. 707/2

(57) ABSTRACT

A method, apparatus and program storage device for optimizing a data warehouse model and operation. Incoming queries issued against a data warehouse having a table join optimized by using a new query reroute technique. The reroute technique also enables data warehouse users to use the standard query-reroute technology to optimize SQL queries issued against a data warehouse that involves recursive hierarchies.

### BACKGROUND OF THE INVENTION

1. Field of the Invention

This invention relates in general to data warehouses, and more particularly to a method, apparatus and program storage device for optimizing a data warehouse model and operation.

2. Description of Related Art

Companies and users are demanding the ability to analyze larger data sets, and to be able to access and report down to more detailed data. The ability to collect, organize, and effectively exploit the mass of data that is available to an organization has long been a goal of those that deploy information systems. Over the years, technologies have evolved from simple reporting systems to fully integrated Business Intelligence (BI) systems, as organizations have strived to make effective use of their business information. Sophisticated tools have been developed to extract data from source systems, transform data, and load data into target systems. Tools for providing queries on the data have likewise evolved to handle the different data structures, the emergence of Web based technologies, and the ever-increasing demands of the information analysts. Database technologies have similarly undergone a series of enhancements in order to try to satisfy the information analysts' requirements.

On-line analytical processing (OLAP) has become increasingly popular. Instead of reviewing piles of static reports, an OLAP analyst can explore business results interactively. This allows the OLAP analyst to dynamically adjust the view of the data, ask questions and receive answers almost immediately. This freedom from static answers to fixed questions on a fixed schedule allows business analysts to operate more effectively and to effect improvements in business operations.

OLAP system can quickly switch among various orientations of dimensions, as well as among various subsets and structural arrangements of a dimension. Because of the multidimensional nature of OLAP systems, the collections of data that they implement are referred to as cubes. As for information, OLAP systems store and calculate information. Data for OLAP systems often come from one or more operational systems. Analytical models are applied to these data, and the results are either stored in the system or generated at query time. The quantity of information that a particular OLAP system can manage is one characteristic of that system.

Enterprises have been storing multidimensional data, using a star or snowflake schema, in relational databases for many years. Relational database vendors have added optimizations that enhance query performance on these schemas. Many special purpose databases have been developed for handling added computational complexity and generally perform better than relational engines.

OLAP systems perform analysis of data that typically comes from relational databases. There are different types of OLAP systems: relational OLAP (ROLAP), hybrid OLAP (HOLAP), and multidimensional OLAP (MOLAP). The different types of OLAP systems vary in the degree to which they use relational databases. ROLAP systems issue queries directly against relational databases and analyze the results. MOLAP products have a proprietary data store, which they populate by reading from a relational database. Then, the MOLAP product responds to queries by reading from the data store. HOLAP products route selected queries to the relational database to obtain data that does not fit in the limited MOLAP data store.

Multidimensional OLAP (MOLAP) refers to the family of OLAP systems in which special-purpose file systems or indexes are used to store cube data. These systems are often read-only systems that are loaded with base data periodically, then derived results are calculated, stored, and indexed. Scalability of MOLAP systems is often limited by the size of the batch window within which derived results are calculated and stored. To improve scalability, such systems often have a means for deferring calculation of some derived results until query time.

For relational OLAP (ROLAP), star schemas have been used for many years as a means for representing multidimensional data in a relational database. Many commercial software development companies have developed batch or interactive multidimensional reporting and exploration interfaces for relational star schemas.

Prior art systems are designed to produce multidimensional reports showing results with different levels of granularity by issuing multiple queries. Multiple result sets are obtained for the multiple queries, and the result sets are merged to form a single report. Such systems depend on some sort of description (metadata) of the roles for the tables and columns in a star schema for generating the necessary SQL to retrieve the data to produce the multidimensional reports. The precise metadata varies from product to product.

Database management systems (DBMSs) traditionally separate the optimization of a query from its execution. SQL queries are compiled once and the resulting Query Execution Plan (QEP, or just plan) is retained to save re-compilation costs for repeated execution in the future. The plan is stored either in the database or in an in-memory cache (for dynamic queries). Most modern query optimizers determine the best plan for executing a given query by mathematically modeling the execution cost for each of many alternative QEPs and choosing the one with the cheapest estimated cost. Query optimizers determine the best execution plan for any query based on a model of query execution cost that relies on the statistics at the time of compilation.

The growth of multidimensional data models has seen an attempt by data modelers to structure data in a way that is more easily understood by the information analyst. A multidimensional data model is typically oriented towards a specific business area, for example a sales model or a finance model. Central to the multidimensional model is the fact table. The fact table holds the business metrics such as unit amounts, monetary values, and business ratios that are applicable to that business subject area. The fact table is joined to a number of dimension tables. These dimension tables reflect the different ways in which a user needs to analyze the business metrics within the fact table, for example sales by customer by month by region. A further objective of the multidimensional model is to reduce the joins required to be performed by the database. By requiring fewer joins, the query should perform faster.

This concept of being able to analyze related business facts by multiple business dimensions is the concept that is exploited with OLAP technology. Using OLAP technologies, related business metrics can be analyzed by dimensions. Each dimension is typically expressed as a hierarchy. For example, the Time dimension could be expressed as a hierarchy of Year, Quarter, Month, and Date. Queries then represent an expression of the business metrics (or facts) for a given slice of the multidimensional database. The term slice is used to depict the domain of facts that all possible queries can access at a given level per dimension, for the full set of dimensions.

Views of intermediate results, i.e., materialized views (MV), which are also known as automated summary table (AST) or materialized query table (MQT), are adapted to accelerate database query processing. Aggregates or summaries of the base data can be created in advance and stored in the database MQTs or MVs. The optimizer is then able to recognize that a specific query requires an aggregation and if it has a relevant MQT available for it to use, can attempt to rewrite the query to run against the MQT instead of the base data. As the MQT is a precomputed summary and/or filtered subset of the base data it tends to be much smaller in size than the base tables from which it was derived, and as such significant performance gains can be made from using the MQT. Most database users will design and build one or more MQTs based on the data model and/or the query workloads. If a user builds the right MQT, a relational database optimizer will use the MQT via query rewrite. In other words, a relational database will automatically reroute incoming queries to MQTs. The optimizer can not only transparently rewrite incoming queries, but also exploit both full and partial matches. So all tools and applications can benefit from MQTs without changes to the tool or application code.

Current modeling processes allow a user to create a table join object that belongs to one of five join categories: 1) outer-join; 2) cross-join; 3) inner-join without a referential-integrity constraint; 4) inner-join with a referential-integrity constraint whose foreign key is null; and 5) inner-join with a referential-integrity constraint whose foreign key is not-null. An inner-join with a many-to-many relation is herein referred to as a cross-join. The term inner-join is reserved for inner-joins with one-to-one, one-to-many, and many-to-one relations. A self-join is a special inner-join with a one-to-one relation in which a table joins a copy of itself.

Since an inner-join, as defined herein, can only have a one-to-one, or one-to-many, or many-to-one relation, a referential-integrity constraint (R1) can be defined for each inner-join to help enforce these relations. Then, when a referential-integrity constraint is defined between two tables, the join columns from one table represent a primary key (PK) or a unique key (UK) of that table, and the join columns from the other table represent a foreign key (FK) of that table. Then by definition, the table columns of a primary key cannot be null, and the table columns of a foreign key can be null or not-null.

Existing techniques for recommending MQTs for a star schema sometimes do not work when a table join object in a cube model belongs to one of the first four join categories. In other words, some MQT recommendation components only support a data warehouse model whose tables join each other using inner-joins with a referential-integrity constraint whose foreign key is not null.

In addition, most Business Intelligence applications today use recursive techniques, such as a recursive SQL syntax or a recursive SQL procedure call, to process data that involves recursive hierarchies. A recursive hierarchy includes a data warehouse having tables that contain information in one column that is a parent or child of information in a second column. For example, an organization chart displaying manager-employee relationships can be created using a recursive hierarchy. In such a hierarchy, the table would have columns for employee ID and manager ID. The manager ID would refer to the employee ID of another employee, resulting in a hierarchy of employees. However, these recursive techniques are not commonly supported by the standard query-reroute technology.

Thus, it can be seen that there is a need for a method, apparatus and program storage device for optimizing a data warehouse model and operation.

### SUMMARY OF THE INVENTION

To overcome the limitations in the prior art described above, and to overcome other limitations that will become apparent upon reading and understanding the present specification, the present invention discloses a method, apparatus and program storage device for optimizing a data warehouse model and operation.

The present invention solves the above-described problems by optimizing an incoming query issued against a data warehouse having a table join by using a new query reroute technique. The reroute technique also enables data warehouse users to use the standard query-reroute technology to optimize SQL queries issued against a data warehouse that involves recursive hierarchies.

A method for optimizing a data warehouse in accordance with an embodiment of the present invention includes decomposing a data warehouse model into a first part and a second part, identifying join columns on the first part of a join object between a table in the first part and a table in the second part, including join columns of the first part in a new data warehouse metadata model represented by the first part plus the join columns, using an optimization technique to recommend at least one summary table on the new data warehouse metadata model and rerouting an incoming query issued against a data warehouse having a table join using at least one summary table derived from the new data warehouse metadata model.

In another embodiment of the present invention, a method for optimizing a data warehouse model involving a recursive hierarchy is provided. This method includes detecting a recursive hierarchy in a data warehouse model, generating a bridge table between a fact table of a data warehouse and a dimension table that contains the recursive hierarchy information, recommending a summary table that includes at least one special table column to facilitate query-reroute against the bridge table and its associated dimension table and using the recommended summary table that includes at least one special table column to reroute a standard SQL issued against the data warehouse model having the recursive hierarchy.

In another embodiment of the present invention, an apparatus for optimizing a data warehouse is provided. This apparatus includes a computer having a data store coupled thereto, wherein the data store stores data for establishing a data warehouse and one or more computer programs, performed by the computer, for decomposing a model of the data warehouse into a first part and a second part, identifying join columns on the first part of a join object between a table in the first part and a table in the second part, including join columns of the first part in a new data warehouse metadata model represented by the first part plus the join columns, using an optimization technique to recommend at least one summary table on the new data warehouse metadata model and rerouting an incoming query issued against a data warehouse having a table join using at least one summary table derived from the new data warehouse metadata model.

In another embodiment of the present invention, a program storage device is provided. The program storage device includes program instructions executable by a processing device to perform operations for optimizing a data warehouse model involving a recursive hierarchy, the operations including decomposing a data warehouse model into a first part and a second part, identifying join columns on the first part of a join object between a table in the first part and a table in the second part, including join columns of the first part in a new data warehouse metadata model represented by the first part plus the join columns, using an optimization technique to recommend at least one summary table on the new data warehouse metadata model and rerouting an incoming query issued against a data warehouse having a table join using at least one summary table derived from the new data warehouse metadata model.

In another embodiment of the present invention, another apparatus for optimizing a data warehouse is provided. This apparatus includes a computer having a data store coupled thereto, wherein the data store stores data for establishing a data warehouse and one or more computer programs, performed by the computer, for detecting a recursive hierarchy in a data warehouse model, generating a bridge table between a fact table of a data warehouse and a dimension table that contains the recursive hierarchy information, recommending a summary table that includes at least one special table column to facilitate query-reroute against the bridge table and its associated dimension table and using the recommended summary table that includes at least one special table column to reroute a standard SQL issued against the data warehouse model having the recursive hierarchy.

In another embodiment of the present invention, another program storage device is provided. This program storage device includes program instructions executable by a processing device to perform operations for optimizing a data warehouse model involving a recursive hierarchy, the operations including detecting a recursive hierarchy in a data warehouse model, generating a bridge table between a fact table of a data warehouse and a dimension table that contains the recursive hierarchy information, recommending a summary table that includes at least one special table column to facilitate query-reroute against the bridge table and its associated dimension table and using the recommended summary table that includes at least one special table column to reroute a standard SQL issued against the data warehouse model having the recursive hierarchy.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a block diagram of a computing environment in accordance with certain implementations of the invention;

FIG. 2 shows a snowflake schema with a SalesFact fact table with Store, Time, Product and Customer dimension tables;

FIG. 3 shows the cube model according to an embodiment of the present invention;

FIG. 4 is a flow chart of a method of a query reroute technique that allows optimization of incoming queries issued against a data warehouse having any type of table join according to an embodiment of the present invention;

FIG. 5 is a diagram of the new data warehouse according to an embodiment of the present invention;

FIG. 6 illustrates a data warehouse having two dimensions;

FIG. 7 shows—a fact table, Expense_Fact, that is used to form one example of a data warehouse;

FIG. 8 illustrates the balanced hierarchy of the Time dimension table;

FIG. 9 illustrates the unbalanced and recursive hierarchy of the Department_Dim table of FIG. 6;

FIG. 10 illustrates a bridge table associated with the Department_Dim table according to an embodiment of the present invention;

FIG. 11 shows a data warehouse model that joins the Expense_Fact table with the Time_Dim table using a lossless join;

FIG. 12 illustrates the cross-join column, Expense_Fact.Department_ID, being modeled into a degenerate dimension, Department2; and

FIG. 13 illustrates a flow chart for optimizing a data warehouse mode involving a recursive hierarchy according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for optimizing a data warehouse model and operation. An incoming query issued against a data warehouse having a table join can be optimized by using a new query reroute technique. Moreover, the reroute technique enables data warehouse users to use the standard query-reroute technology to optimize SQL queries issued against a data warehouse that involves recursive hierarchies.

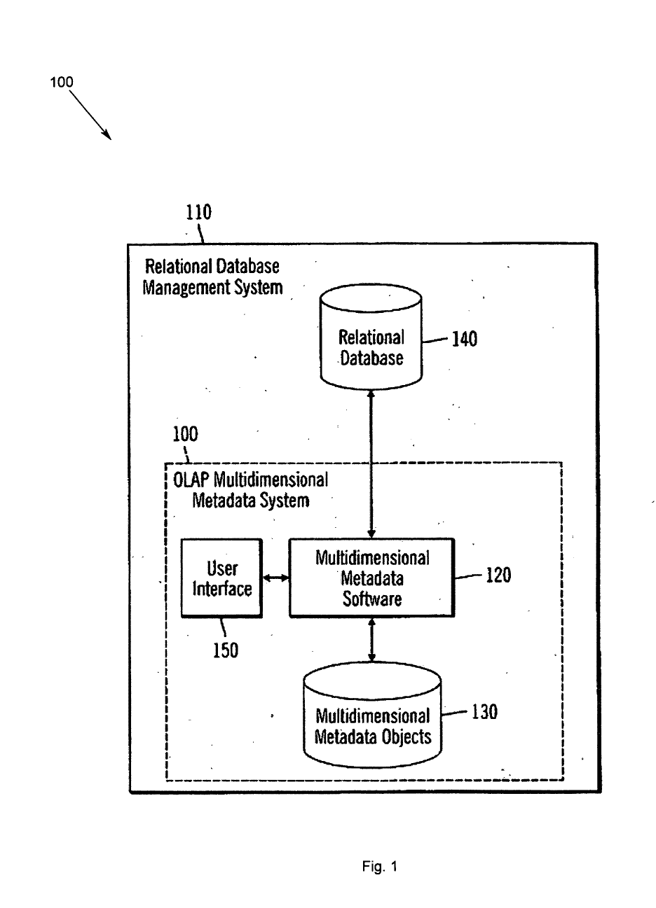

FIG. 1 illustrates a block diagram of a computing environment 100 in accordance with certain implementations of the invention. A Relational Database Management System (RDBMS) 110 includes multidimensional metadata software 120 (e.g., a stored procedure application programming interface (API)) and a user interface 150. The RDBMS 110 accesses multidimensional metadata objects 130 and a relational database 140. In certain implementations, the data in multidimensional metadata objects 130 and relational database 140 may be stored in a single database.

An OLAP multidimensional metadata system 100 includes multidimensional metadata software 120 (e.g., a stored procedure application programming interface (API)), a user interface 150, and multidimensional metadata objects 130. Multidimensional metadata objects 130 are metadata objects that are used to dimensionally model the relational data and OLAP structures. The multidimensional metadata software 120 is used to create, store, and access the multidimensional metadata objects 130. Optionally, a user interface 150 may be provided for a user or administrator to send commands to the multidimensional metadata software 120. A user may create, access, modify, or delete multidimensional metadata objects 130 by submitting commands via the user interface 150. The commands are received and processed by the multidimensional metadata software 120. For example, the multidimensional metadata software 120 may create and store multidimensional metadata objects 130.

In certain implementations, the OLAP multidimensional metadata system 100 provides an add-on feature for an RDBMS 110, such as DB2® Universal Database (referred to herein as DB2® UDB), that improves the ability of the RDBMS 110 to perform OLAP processing. According to an embodiment of the present invention, the deployment and management of OLAP solutions are streamlined and the performance of OLAP tools and applications are improved.

In particular, the OLAP multidimensional metadata system 100 provides metadata objects. The new metadata objects are stored in, for example, a database catalog (e.g., the DB2® UDB catalog) that describes the dimensional model and OLAP constructs of existing relational data. The database catalog provides a single repository from which OLAP applications can capture multidimensional metadata. In certain implementations, the metadata objects may reside on a data store other than the database catalog or may reside across multiple data stores. With the information in the central repository, a database optimizer is able to use techniques specific to star schemas for optimizing the execution of queries.

With the help of multidimensional metadata objects, OLAP query performance may be optimized by pre-aggregating data into summary tables and creating indexes. The OLAP multidimensional metadata system 100 also provides a metadata programming interface. In particular, the OLAP multidimensional metadata system 100 provides an SQL and extensible mark-up language (XML)-based application programming interface (API) for OLAP tools and application developers. XML is a text format defined by the World Wide Web Consortium (W3C) and further details on XML may be found at Extensible Markup Language (XML) 1.0 (Second Edition) W3C Recommendation 6 Oct. 2000.

OLAP multidimensional metadata system 100 metadata objects describe relational information as intelligent OLAP structures. The multidimensional metadata objects 130 provided according to an embodiment of the present invention store metadata, meaning the metadata objects store information about the data in the base tables. Metadata objects describe where pertinent data is located and can also describe relationships within the base data. For example, a facts metadata object is an OLAP metadata object that stores information about related measures, attributes and joins, but does not include the data specifically from the base fact table.

Each metadata object completes a piece of the big picture showing what the relational data means. Some metadata objects act as a base to directly access relational data by aggregating data or directly corresponding to particular columns in relational tables. Other metadata objects describe relationships between the base metadata objects and link these base metadata objects together. Ultimately, all of the metadata objects can be grouped together by their relationships to each other, into a metadata object called a cube model.

A cube model represents a particular grouping and configuration of relational tables. The purpose of a cube model is to describe OLAP structures to a given application or tool. Cube models tend to describe all cubes that different users might want for the data that are being analyzed. A cube model groups dimensions and facts, and offers the flexibility of multiple hierarchies for dimensions. A cube model conveys the structural information needed by query design tools and applications that generate complex queries on star schema databases.

The model of the multidimensional metadata objects 130 is designed to describe the schemas used in relational databases to represent multidimensional data. One way to organize such data is by using a star or snowflake schema (in snowflake schemas the dimension tables are normalized). However, the model is flexible enough to handle any type of schema (e.g., more normalized schemas).

Multidimensional metadata objects 130 help the data warehouse designer represent the structural relationship among tables and their columns of the data warehouse provided by the RDBMS 110. Once this metadata exists in the database catalog, other components of the RDBMS 110, such as a database optimizer (e.g., a DB2® UDB optimizer), can take advantage of the structural information and execute queries, against data described by these new OLAP metadata objects, faster. The metadata objects can also assist business intelligence tools by providing the base structural information needed to generate multidimensional queries against the data warehouse when these tools do not have their own metadata management subsystems.

In certain implementations, the OLAP multidimensional metadata system 100 is implemented in a DB2® Universal Database (UDB) RDBMS, available from International Business Machines, Inc. Although the present specification describes the use of IBM's DB2® UDB RDBMS software, those skilled in the art will recognize that the present invention can use other RDBMS software, such as RDBMS software available from Oracle, Microsoft, Informix, Sybase, and Teradata. Additionally, the present invention can run on computers using various operating systems, such as IBM z/OS®, IBM AIX®, Microsoft Windows® 2000, Microsoft Windows® XP, Linux, Solaris, HP-UX, etc.

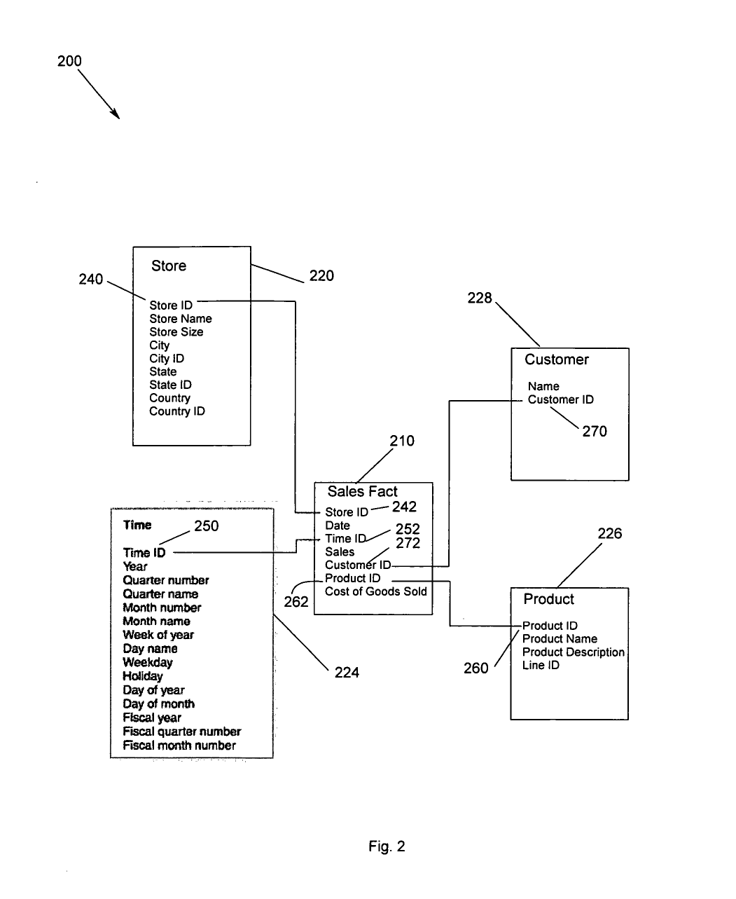

FIG. 2 shows a star schema 200 with a SalesFact fact table 210 with Store 220, Time 224, Product 226 and Customer 228 dimension tables. The primary key in each primary dimension table (Store 220, Time 224, Customer 228 and Product 226) is joined to the corresponding foreign key in the SalesFact fact table 210. For example, Store.StoreID 240 =SalesFact.StoreID 242, Time.TimeID 250 =SalesFact.TimeID 252, Product.ProductID 260 =SalesFact.ProductID 262 and SalesFact.CustomerID 270 =Customer.CustomerID 272.

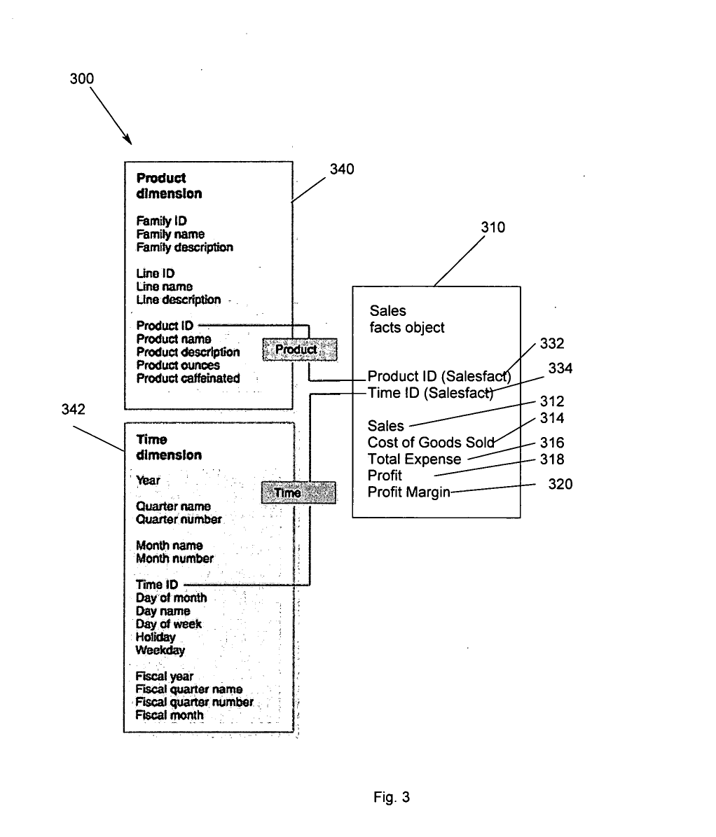

FIG. 3 shows the cube model 300 according to an embodiment of the present invention. In FIG. 3, the cube model 300 is built around the SalesFact fact object 310 that describes aggregated relational data from the SalesFact fact table 210 of FIG. 2. Dimensions are connected to the facts object in a cube model like the dimension tables are connected to the fact table in a star schema. Columns of data from relational tables are represented by attribute objects referenced by the dimension.

In FIG. 3, measures describe how to calculate data from columns in the Sales fact table. The facts object 310 also includes attributes that correspond to the foreign keys in the fact table that are used to join the dimensions to the facts object. In this example, the Sales fact object 310 has five measures: Sales 312, Cost of goods sold 314, Total expense 316, Profit 318, and Profit margin 320. The Sales facts object 310 has two attributes: TimeID (Salesfact) 334 and ProductID (Salesfact) 332.

The Product dimension 340 references the following attributes:
Family ID
Family name
Family description
Line ID
Line name
Line description
Product ID
Product name
Product description
Product ounces
Product caffeinated

The Time dimension 342 references the following attributes:
Time ID
Year
Quarter name
Quarter number
Month name
Month number
Day of month
Day name
Day of week
Holiday
Weekday
Fiscal year
Fiscal quarter name
Fiscal quarter number
Fiscal month.

A join may be created to connect each dimension 340-342 to the facts object 310. A join is a metadata object that describes a combination of columns from two relational tables. A join references attributes that reference columns in the tables being joined.

The simplest form of a join references two attributes, i.e., one that maps to a column in the first table and one that maps to a column in the second table. An operator may also be specified to indicate how the columns will be compared. A join can also model composite joins where two or more columns from the first table are joined to the same number of columns in the second table. A join also has a type and cardinality. The join types map to relational join types. Joins are primarily used to join the cube model's dimensions to its facts object. Joins can also be used to join dimension tables together in a snowflake schema, or to join multiple fact tables together within a facts object. In FIG. 3, two joins are shown. The two joins are Product, and Time.

Current modeling processes allow a user to create a table join object that belongs to one of five join categories: 1) outer-join; 2) cross-join; 3) inner-join without a referential-integrity constraint; 4) inner-join with a referential-integrity constraint whose foreign key is null; and 5) inner-join with a referential-integrity constraint whose foreign key is not-null. An inner-join with a many-to-many relation is herein referred to as a cross-join. The term inner-join is reserved for inner-joins with one-to-one, one-to-many, and many-to-one relations. A self-join is a special inner-join with a one-to-one relation in which a table joins a copy of itself.

Since an inner-join, as defined herein, can only have a one-to-one, or one-to-many, or many-to-one relation, a referential-integrity constraint (RI) can be defined for each inner-join to help enforce these relations. Then, when a referential-integrity constraint is defined between two tables, the join columns from one table represent a primary key (PK) or a unique key (UK) of that table, and the join columns from the other table represent a foreign key (FK) of that table. Then by definition, the table columns of a primary key cannot be null, and the table columns of a foreign key can be null or not-null.

However, some optimization validation processes will stop the MQT recommendation process whenever the optimization validation process finds that a table join object in a cube model belongs to one of the first four join categories. In other words, some MQT recommendation components only support a data warehouse model whose tables join each other using inner-joins with a referential-integrity constraint whose foreign key is not null.

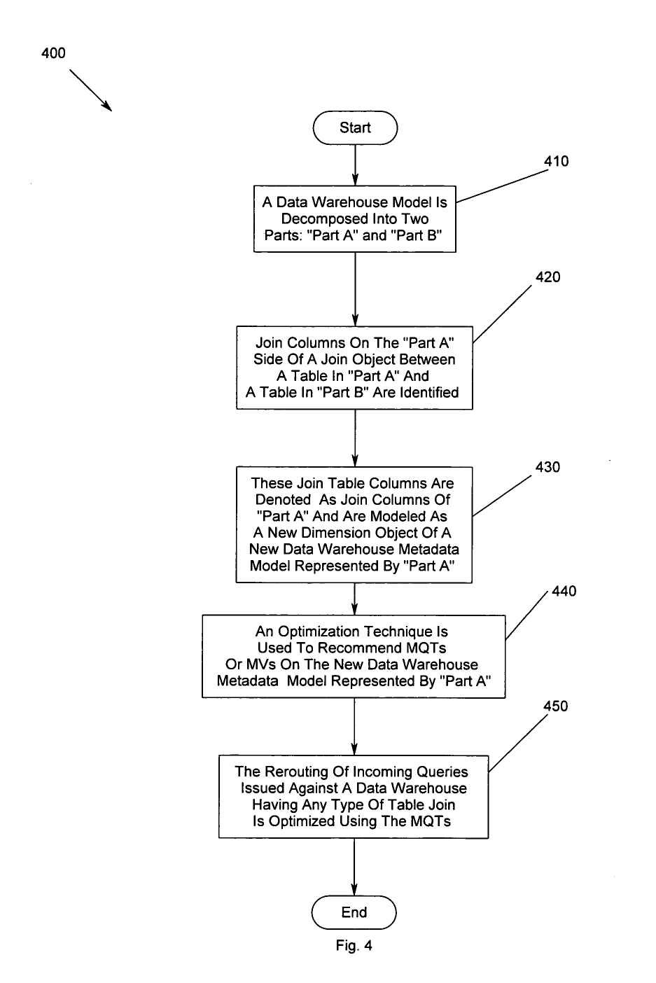

FIG. 4 is a flow chart 400 of a method of a query reroute technique that allows optimization of incoming queries issued against a data warehouse having any type of table join according to an embodiment of the present invention. In FIG. 4, a data warehouse model is decomposed into two parts 410, e.g., part A and part B. Part A includes tables of this data warehouse that joins a table of a facts object with a table of a dimension object and that joins two tables of a dimension object using inner-joins with not-null foreign keys. Part B includes tables of this data warehouse that are not in Part A. Join columns on the Part A side of a join object between a table in Part A and a table in Part B are identified 420. These join table columns are denoted as Join Columns of Part A and are modeled as a new dimension object of a new data warehouse metadata model represented by Part A 430. Then, an optimization technique is used to recommend Materialized Query Tables (MQTs) or Materialized Views (MVs) on the new data warehouse metadata model represented by Part A 440. The rerouting of incoming queries issued against a data warehouse having any type of table join is optimized using the MQTs 450.

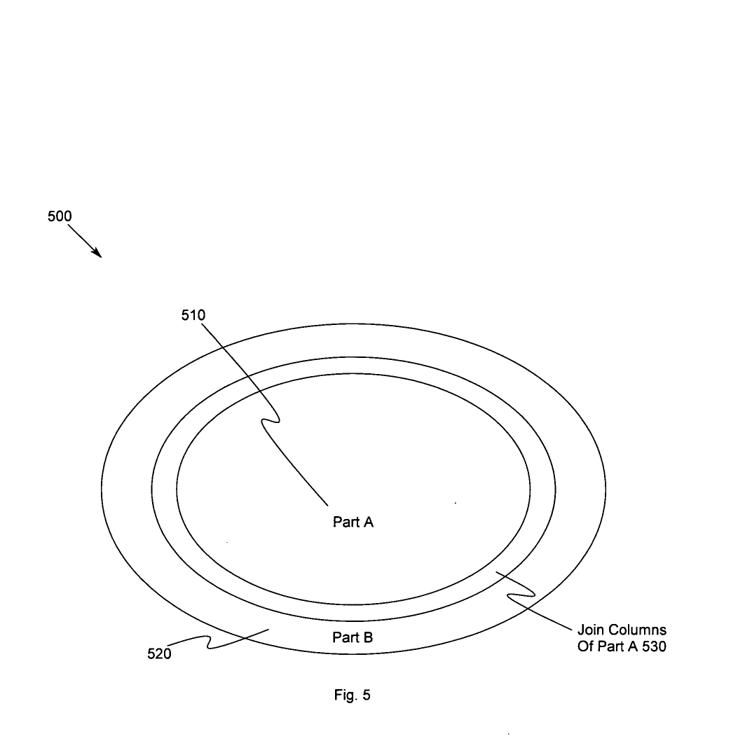

FIG. 5 is a diagram of the new data warehouse 500 according to an embodiment of the present invention. The new data warehouse 500 includes Part A 510, and Join columns of Part A 530.

Accordingly, to optimize queries against a data warehouse model that involves an outer-join object, or a cross-join object, or an inner-join object whose foreign key is null, the data warehouse model may be decomposed into two parts, A and B, such that Part A consists of tables of this data warehouse that join its fact tables with its dimension tables using inner-joins with not-null join columns, and Part B consists of tables of this data warehouse that are not in Part A.

Then if a suitable MQT is found for Part A, this MQT and tables in Part B will be used to reroute an incoming query issued against this data warehouse (Part A+Part B). For example, if an incoming query is issued against a data warehouse that involves a cross-join:

```
Select
      Time.Quarter,
      Store.State,
      Customer.Name,
      Sum(SalesFact.Sales)
From
      Time InnerJoin SalesFact on (SalesFact.Date == Time.Date)
      InnerJoin Store on (SalesFact.StoreID = Store.StoreID)
      CrossJoin Customer on (SalesFact.CustomerID ==
Customer.CustomerID)
GroupBy
      Time.Quarter,
      Store.State,
      Customer.Name
```

And a MQT is defined as:

```
Create table SampleMQT as
(
    Select
        Time.MonthID,
        Product.LineID,
        Store.CityID,
        SalesFact.CustomerID,
        Sum(SalesFact.Sales)
    From
        Time InnerJoin SalesFact on (SalesFact.Date ==
Time.Date)
        InnerJoin Product on (SalesFact.ProductID ==
Product.ProductID)
        InnerJoin Store on (SalesFact.StoreID = Store.StoreID
    GroupBy
        Time.MonthID,
        Product.LineID,
        Store.CityID,
        SalesFact.CustomerID
) data initially deferred refresh deferred;
```

The incoming query will be rerouted to this MQT as follows:

```
    Select
        Time-Month.Quarter,
        Store-City.State,
        Customer.Name,
        Sum(SampleMQT.Sales)
    From
        SampleMQT InnerJoin Time-Month on
(SampleMQT.MonthID ==  Time-Month.MonthID)
        InnerJoin Store-City on (SampleMQT.CityID == Store-
City.CityID)
        CrossJoin Customer on (SampleMQT.CustomerID ==
    Customer.CustomerID)
    GroupBy
        Time-Month.Quarter,
        Store-City.State,
        Customer.Name
```

In this example, the original data warehouse that includes tables (SalesFact, Time, Product, Store, Customer) is divided into two parts: A=(SalesFact, Time, Product, Store) and B=(Customer), such that Part A represents a new data warehouse whose fact tables join its dimension tables using inner-joins with not-null join columns. And tables Time-Month and Store-City are sub-dimension tables that are defined as follows:
Select Time.MonthID, Time.Month, Time.QuarterID, Time.Quarter, Time.Year
From Time
Group By Time.MonthID, Time.Month, Time.QuarterID, Time.Quarter, Time.Year
Select Store.CityID, Store.City, Store.StateID, Store.State. Store.CountryID, Store.Country
From Store
Group By Store.CityID, Store.City, Store.StateID, Store.State. Store.CountryID, Store.Country

Then to reroute incoming queries issued against the original data warehouse, the following query-reroute technique is used. As described above with reference to FIG. 4, some MQTs for this new data warehouse model (consisting of Part A and the join columns of Part A) are recommended. Then, for each incoming query, tables used in this incoming query are matched with tables used in a MQT's definition query such that tables of an incoming query and tables of a MQT can be divided into three groups (i.e., M, N and L) as follows:
Query: matched tables (M) and unmatched tables (N) in this query
MQT: matched tables (M) and unmatched tables (L) in this MQT Next, a MQT is considered for query-reroute if:
1. There is at least one table in M.
2. Tables in L form lossless joins with some tables in M.
3. Tables in N are joinable with this MQT.
   The second criterion ensures that the extra tables appeared in a MQT do not change the data granularity of this MQT. The third criterion ensures that the following relationship holds

GroupBy(Tables in M join Tables in N)=GroupBy(MQT join Tables in N), where the join can be an outer-join, or a cross-join, or an inner-join without RI, or an inner-join with RI whose foreign key is null or not-null. So, with this technique, we will be able to optimize incoming queries issued against a data warehouse whose table-joins belong to any one of these five join categories.

To make the query-reroute technique according to an embodiment of the present invention work, three key elements need to be implemented:
Ability to decompose a user-defined data warehouse into two parts, A and B, such that Part A represents a new data warehouse whose fact tables join its dimension tables using inner-joins with not-null join columns and Part B represents rest of the tables of this user-defined data warehouse.
Ability to recommend MQTs on this new data warehouse.
Ability to recommend MQTs on this new data warehouse such that these MQTs include specific table columns of this new data warehouse that can be used to join tables in Part B at run-time.

Part A of a user-defined data warehouse can be determined by examining table joins between a fact and a dimension table, and between two sub-dimension tables. This is done by classifying tables of a given data warehouse into a collection (starting from the fact tables) such that the collected fact and dimension tables join each other using inner-joins with not-null join columns. Then as soon as we encounter a join between a fact and a dimension tables, or between two dimension tables that is an outer-join, or a cross-join, or an inner-join with a nullable foreign key, we define a logical section of the boundary of Part A between these two tables, say T1 and T2, such that T1 belongs to Part A and T2 belongs to Part B. Next, we identify table column(s) of T1 that are part of this join and denote them as Join columns of Part A. For example, in the sample data warehouse that includes tables (SalesFact, Time, Product, Store, Customer), we will create a table collection and add tables SalesFact, Time, Product, and Store to this collection. Then for the Customer table, we detect that the join between SalesFact and Customer is a cross-join. Therefore, we define a logical section of the boundary of Part A between these two tables and identify and denote table column, SalesFact.CustomerID, as a Join column of Part A.

After we have identified a new data warehouse model and the Join columns of this new data warehouse model from a user-defined data warehouse model, we need to represent these Join columns in some OLAP metadata objects such that they can be added to the cube model that represents this new data warehouse model, and be considered by the MQT recommendation component as a part of recommended MQTs on this new data warehouse. One way to represent the Join columns of Part A in a fact-to-dimension join object is to model the Join columns of Part A as a level object of a new degenerate dimension object (whose columns are fully embedded in a fact table). In the above specific example, we can model the table column, SalesFact.CustomerID, into a level object of a new degenerate dimension object. If the Join columns of Part A appear in a dimension-to-dimension join object, we can model the Join columns of Part A as a new level object.

A further example is provided herein. A sample data warehouse system that has a Sales_Fact table, a Time_Dim table, and a Customer_Dim table:

create table sales_fact
(

| | | |
|---|---|---|
| customer_id | integer, | |
| day_id | date | not null, |
| sales | double | not null |
| ); | | |
| create table time_dim | | |
| ( | | |
| day_id | date | not null, |
| month1970 | integer | not null, |
| month | varchar(10) | not null, |

month_number integer not null,

| | | |
|---|---|---|
| quarter1970 | integer | not null, |
| quarter | varchar(2) | not null, |
| year | integer | not null, |

constraint pk_time_dim primary key (day_id)
);
create table customer_dim
(

| | | |
|---|---|---|
| customer_id | integer | not null, |
| customer_name | varchar(20) | not null, |

```
  constraint pk_customer_dim primary key (customer_id)
);
alter table sales_fact add foreign key (day_id)
  references time_dim (day_id) on delete restrict;
alter table sales_fact add foreign key (customer_id)
  references customer_dim (customer_id) on delete restrict;
```

In this case, the sample data warehouse will be divided into two parts: A=(Sales_Fact, Time_Dim) and B=(Customer_Dim), simply because for the Customer_Dim table, we detect that the join between Sales_Fact and Customer_Dim is an inner-join with a nullable foreign key. Therefore, we denote the table column, Sales_Fact.Customer_ID, as a join column of Part A and model it into a level object of a new degenerate dimension object. Finally, we add this new degenerate dimension object to a cube model object that represents tables Sales_Fact and Time_Dim, and submit this new cube model object for MQT recommendation.

Accordingly, the query-reroute technique according to an embodiment of the present invention enables incoming queries issued against a data warehouse having any type of table join to be optimized.

As mentioned earlier most techniques today use a recursive SQL syntax or a recursive SQL procedure call to process data that involves recursive hierarchies. However, these recursive techniques are not supported by the standard query-reroute technology. A reroute technique according to an embodiment of the present invention is provided to enable data warehouse users to use the standard query-reroute technology to optimize SQL queries issued against a data warehouse that involves recursive hierarchies.

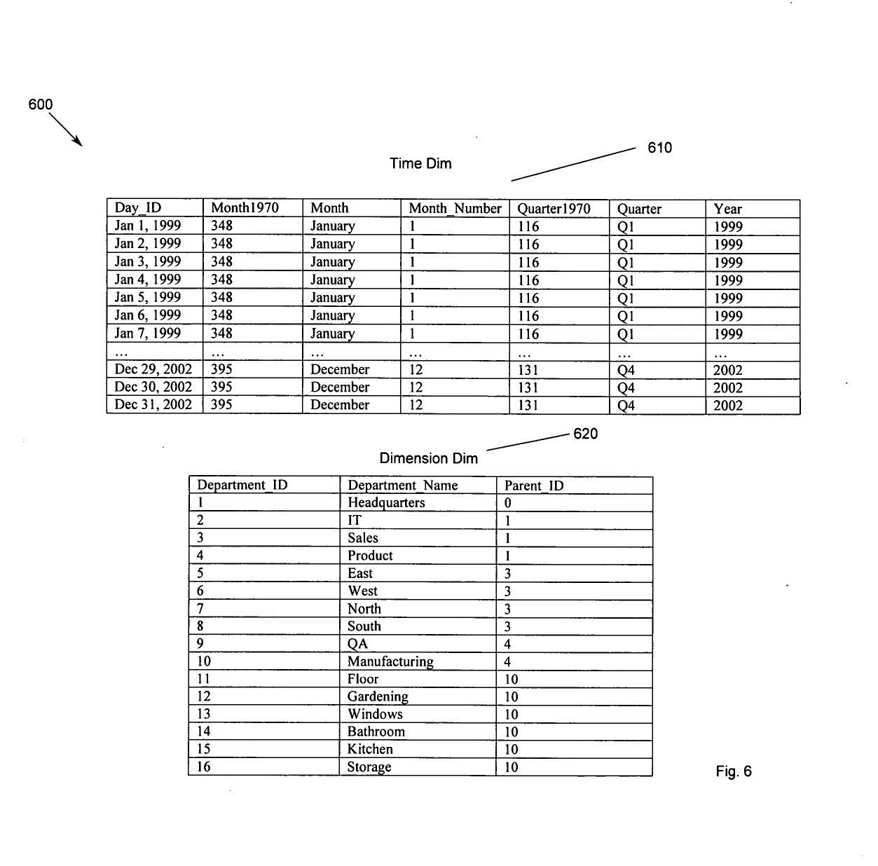

Hierarchies store information about how the attributes grouped into levels within a dimension are related to each other and structured. A hierarchy is an organizational scheme of data entities of a dimension in a data warehouse. FIG. 6 illustrates a data warehouse 600 having two dimensions, i.e., Time 610 and Department 620. As a metadata object, a hierarchy provides a way to calculate and navigate across the dimension. Each dimension 610, 620 has a corresponding hierarchy with levels that group related attributes. In a cube model, each dimension 610, 620 can have multiple hierarchies.

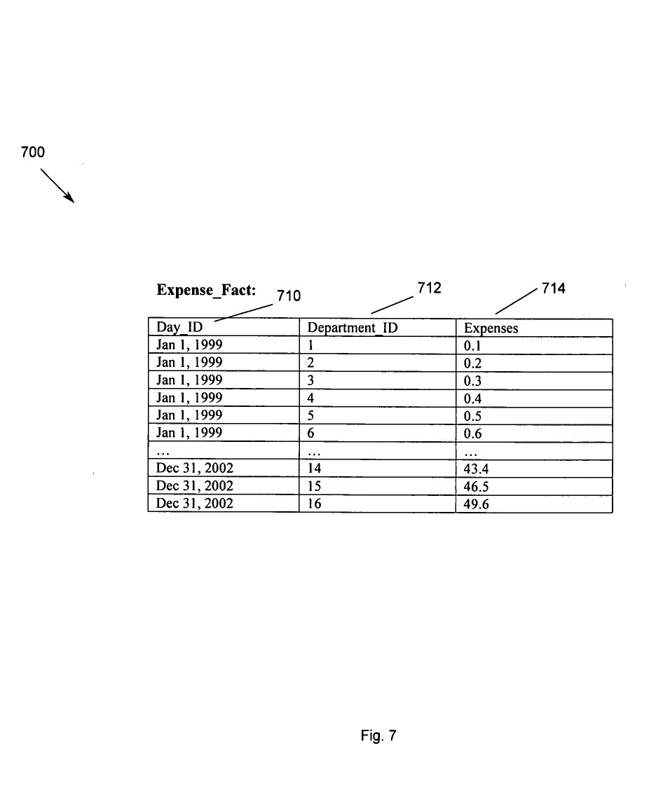

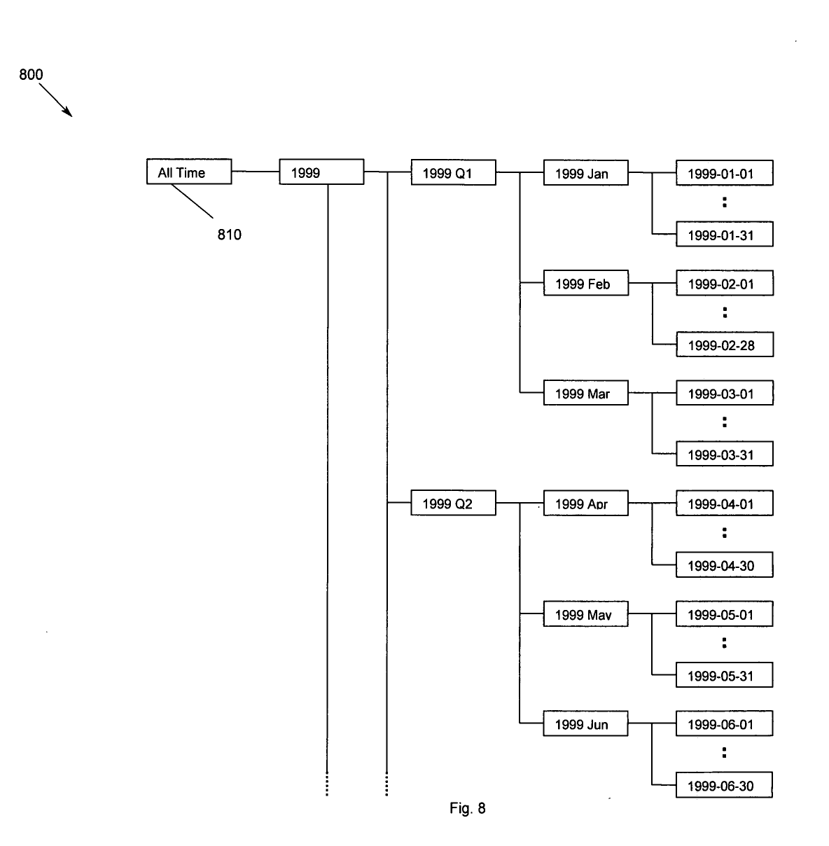

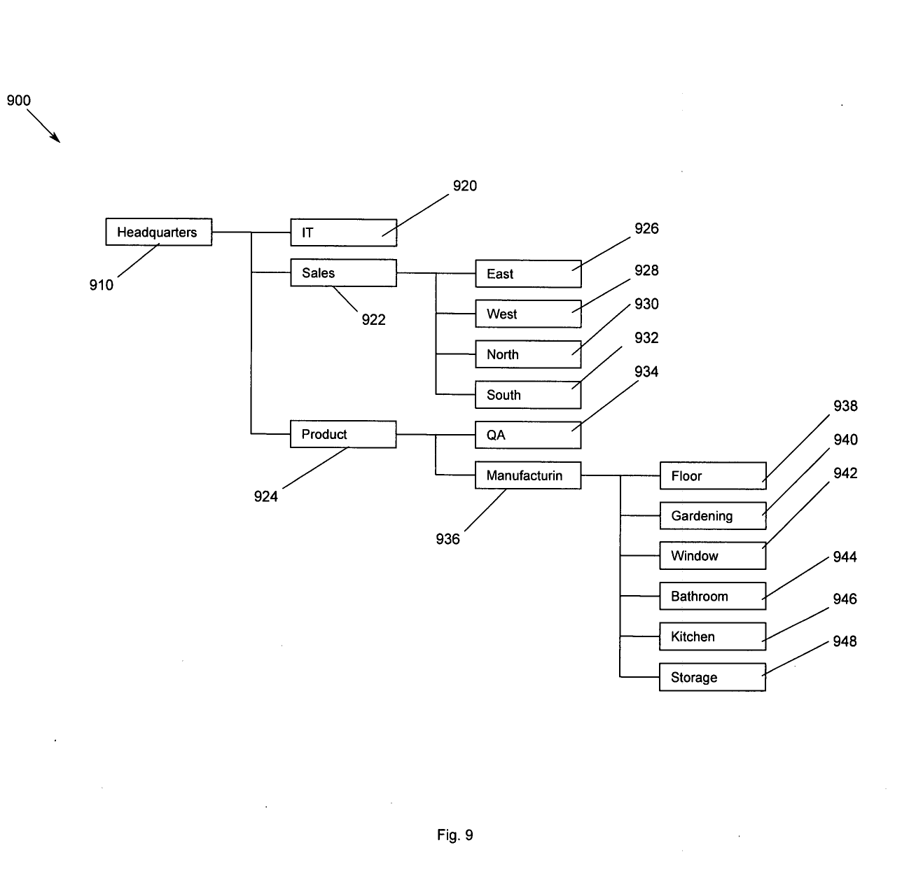

FIG. 7 shows—a fact table, Expense_Fact 700, that is used to form one example of a data warehouse. In FIG. 7, the Expense_Fact table 700 includes columns for a Day ID 710, a Department ID 712 and Expenses 714. Referring to the Time_Dim table of FIG. 6, the data entities of the Time dimension table represent a balanced hierarchy. FIG. 8 illustrates the balanced hierarchy 800 of the Time dimension table. Similarly, referring to the Department_Dim table of FIG. 6, the data entities of the Department dimension represent an unbalanced and recursive hierarchy. FIG. 9 illustrates the unbalanced and recursive hierarchy 900 of the Department_Dim table of FIG. 6.

Referring to FIG. 8, the hierarchy in the Time dimension 800 is balanced as all leaf nodes are at the same distance from the root node 810. Referring to FIG. 9, the hierarchy in the Department dimension 900 is unbalanced as all leaf nodes are not at the same distance from the root node 910. The hierarchy in the Department dimension 900 is recursive as all data entities in this hierarchy belong to the same Department category, but are related to each other through a parent-child relationship between two department nodes 922, 924 except the root node 910.

Business analytics associated with a data entity with respect to all its descendants in a recursive hierarchy are usually determined using a recursive computational algorithm. For example, if the total expense of the Product division including its sub-divisions needs to be computed, the total expense of the Floor, Gardening, Window, Bathroom, Kitchen, and Storage departments are computed first. Then the total expense of the QA and Manufacturing departments are computed next. Finally, the total expense of the Product department is computed.

Though a recursive computational algorithm discussed above can be easily implemented in a computer program or a user-defined routine, it is difficult to implement it in standard SQLs. To address this issue, a bridge or helper table approach is used. The bridge or helper table connects a node in a recursive hierarchy to all its descendant nodes and itself.

For example, referring to FIG. 9, node1 (Headquarters) 910 connects to its descendants' node2 (IT) 920, node3 (Sales) 922, . . . , nodel6 (Storage) 948 and itself, node1 (Headquarters) 910. Node2 (IT) 920 connects to itself since it does not have any descendants. Node3 (Sales) 922 connects to its descendants node5 (East) 926, node6 (West) 928, node7 (North) 930, node8 (South) 932 and itself, node3 (Sales) 922, and so on. Therefore, in this way, a customized aggregation formula is defined for each node in the Department hierarchy.

```
    AggregateFunc(Node1) = M(Node2) + ... + M(Node16) +
    M(Node1) AggregateFunc(Node2) = M(Node2)
    AggregateFunc(Node3) = M(Node5) + M(Node6) + M(Node7) +
M(Node8) + M(Node3)
    ...
    ...
    AggregateFunc(Node16) = M(Node 16)
```

where M stands for a Measure such as expenses.

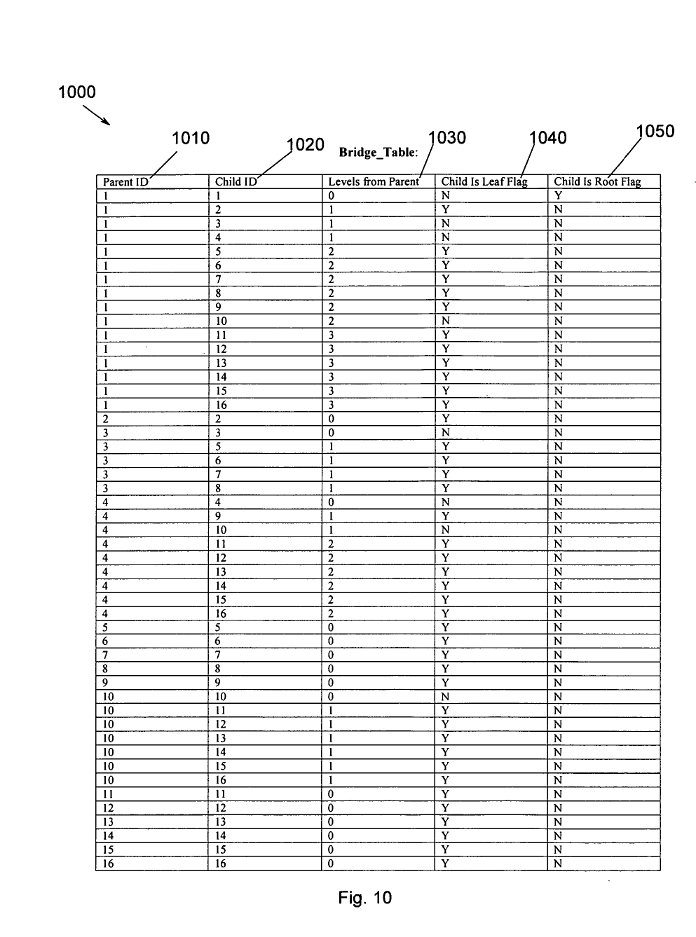

FIG. 10 illustrates a bridge table 1000 associated with the Department_Dim table according to an embodiment of the present invention. The “Department_ID” column value of each row in the Department_Dim table is used to represent a node in the Department hierarchy. For example, the bridge table 1000 includes a Parent ID column 1010 and Child ID column 1020. Parent ID 1 refers to node 1 (Headquarters) 910 of FIG. 9. Parent ID 1 has sixteen child IDs associated with it. Parent ID 2 refers to node 2 (IT) 920 of FIG. 9. Parent ID 2 only has one child ID associated with it, itself. Parent ID 3 has five child IDs associated with it including itself. Parent ID 3 refers to node 3 (Sales) 922 of FIG. 9. This arrangement continues until the last node, i.e., node 16. The bridge table also includes an indication of the levels from the parent node 1030, whether the child is a leaf flag 1040 and whether the child is a root flag 1050.

The bridge table 1000 may then be used to help compute business analytics associated with data entities in the Department hierarchy using a standard SQL query such as follows.

Query 1:

```
select
    c.department_id,
    c.department_name,
    sum(a.expenses)
from
    recur.expense_fact a,
    recur.bridge_table b,
    recur.department_dim c
where
    b.child_id = a.department_id and
    c.department_id = b.parent_id
group by
    c.department_id,
    c.department_name;
```

The table-join between the Expense_Fact table and the Bridge_Table table is a cross-join that ensures that a measure associated with an Expense_Fact table record will go into multiple AggregationFuncs implicitly defined by the Bridge_Table.

In addition to computing aggregates of all date entities of the Department hierarchy as shown in Query1, the “Levels from Parent” information in the Bridge_Table may be used to compute aggregates of a subset of date entities along the Department hierarchy using the standard SQL query. For example, the following query allows the computation of aggregates of nodes that are two levels below the “Headquarters” node.

Query2:

```
select
  c.department_id,
  c.department_name,
  sum(a.expenses)
from
  recur.expense_fact a,
  recur.bridge_table b,
  recur.department_dim c
where
  b.child_id = a.department_id and
  c.department_id = b.parent_id and
  c.department_id in
    (select
      a.child_id
    from
      recur.bridge_table a,
      recur.department_dim b
    where
      b.department_id = a.parent_id and
      b.department_name = ‘Headquarters’ and
      a.levels_from_parent = 2)
group by
  c.department_id,
  c.department_name;
```

In addition, the following standard SQL query will allow the computation of aggregates of all ancestor nodes of the “Gardening” node.

Query3:

```
select
    c.department_id,
    c.department_name,
    sum(a.expenses)
from
    recur.expense_fact a,
    recur.bridge_table b,
    recur.department_dim c
where
    b.child_id = a.department_id and
    c.department_id = b.parent_id and
    c.department_id in
        (select
            a.parent_id
        from
            recur.bridge_table a,
            recur.department_dim b
        where
            b.department_id = a.child_id and
            b.department_name = ‘Gardening’ and
            a.levels_from_parent > 0)
group by
    c.department_id,
    c.department_name;
```

In this case, the sample data warehouse: (Expense_Fact, Time_Dim, Department_Dim) are expanded into a new data warehouse: (Expense_Fact, Time_Dim, Bridge_Table, Department_Dim) such that we can derive various kinds of business analytics from both dimensions using stardard SQL queries. Next, in order to optimize standard SQL queries in this new data warehouse, we divide it into two parts: A=(Expense_Fact, Time_Dim) and B=(Bridge_Table, Department_Dim). This is because we detect that the join between Expense_Fact and Bridge_Table is a cross-join. Therefore, we denote the table column, Expense_Fact.Department_ID, as a join column of Part A and model it into a level object of a new degenerate dimension object, Department2. Finally, we add this new degenerate dimension object to a cube model object that represents tables Expense_Fact and Time_Dim, and submit this new cube model object for MQT recommendation.

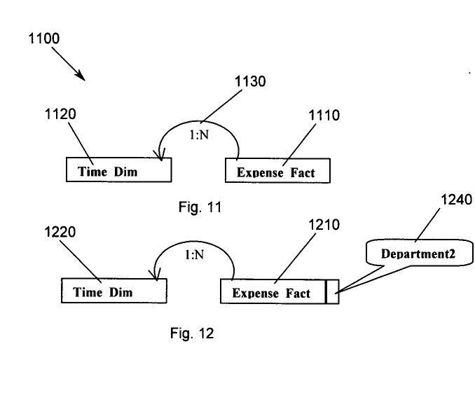

FIG. 11 shows a data warehouse model 1100 that joins the Expense_Fact table 1110 with the Time_Dim table 1120 using a lossless join 1130. FIG. 12 illustrates the cross-join column, Expense_Fact.Department_ID, being modeled into a degenerate dimension, Department2. This degenerate dimension, Department2 1240, is added to the data warehouse model that consists of Expense_Fact 1210 and Time_Dim 1220 tables.

If a MQT is created at the month-level of the Time dimension and the department-level of the Department2 dimension, then the resulting MQT mqt_month_department2 will look like this:

```
create summary table mqt_month_department2 as
(
    select
        b.month1970,
        a.department_id,
        sum(a.expenses) as expenses
    from
        expense_fact a,
        time_dim b
    where
        b.day_id = a.day_id
    group by
        b.month1970,
        a.department_id
)
data initially deferred refresh deferred;
```

For example, if we have an incoming query:

Query4:

```
select
    c.department_id,
    c.department_name,
    sum(a.expenses)
from
    recur.expense_fact a,
    recur.bridge_table b,
    recur.department_dim c
where
    b.child_id = a.department_id and
    c.department_id = b.parent_id
group by
    c.department_id,
    c.department_name;
```

The matched table of this incoming query with mqt_month_department2 is (Expense_Fact); the unmatched tables of this incoming query are (Bridge_Table, Department_Dim); and the unmatched table of this MQT is (Time_Dim). Since Time_Dim forms lossless join with Expense_Fact, and (Bridge_Table, Department_Dim) are joinable with this MQT, this incoming query will be rerouted to MQT mqt_month_department2 as follows:

```
select
    c.department_id,
    c.department_name,
    sum(a.expenses)
from
    recur.mqt_month_department2 a,
    recur.bridge_table b,
    recur.department_dim c
where
    b.child_id = a.department_id and
    c.department_id = b.parent_id
group by
    c.department_id,
    c.department_name;
```

For a data warehouse model that involves a recursive hierarchy, a user can construct a bridge table to help compute business analytics associated with this recursive hierarchy using standard SQLs. A new MQT recommendation process according to an embodiment of the present invention recommends MQTs on a new data warehouse model constructed after the original dimension containing a recursive hierarchy is replaced by a degenerate dimension.

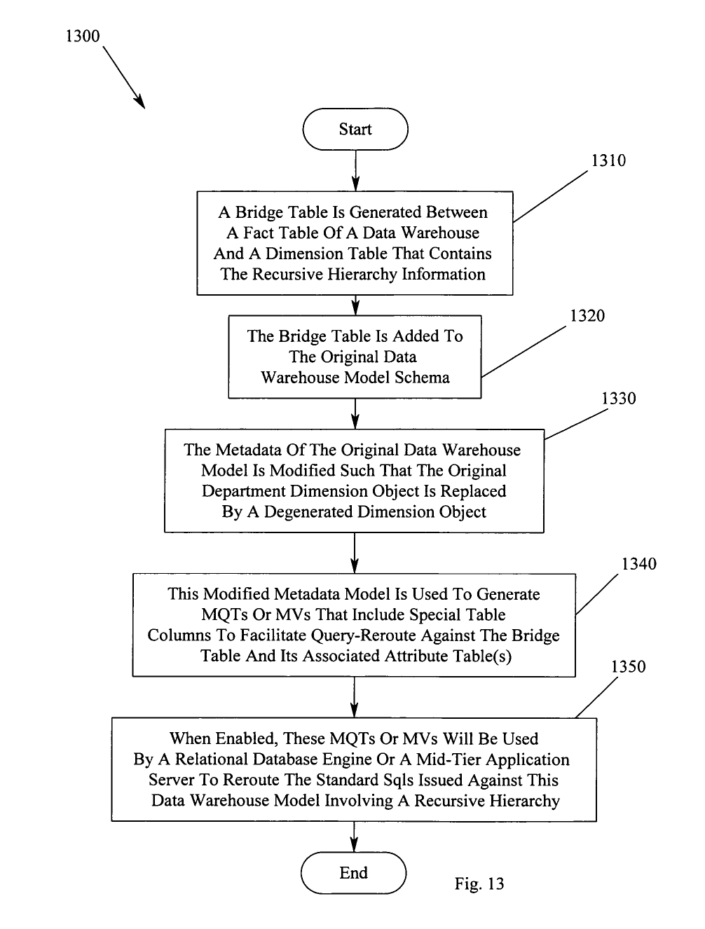

FIG. 13 illustrates a flow chart 1300 for optimizing a data warehouse mode involving a recursive hierarchy according to an embodiment of the present invention. In FIG. 13, a bridge table is generated between a fact table of a data warehouse and a dimension table that contains the recursive hierarchy information 1310. In this way, the stardard SQLs can be used to query the data from the recursive hierarchy. Then, this bridge table is added to the original data warehouse schema 1320. Next, the metadata of the original data warehouse model is modified such that the original Department dimension object is replaced by a degenerated dimension object, Department 2 1330. Finally, this modified metadata model is used to generate materialized query tables (MQTs) or materialized views (MVs) that include special table columns to facilitate query-reroute against the bridge table and its associated attribute table(s) 1340. When enabled, these MQTs or MVs will be used by a relational database engine or a mid-tier application server to reroute the standard SQLs issued against this data warehouse model involving a recursive hierarchy 1350.

The foregoing description of the embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for optimizing a data warehouse having a table join, comprising:
decomposing a data warehouse model into a first part and a second part;
identifying join columns on the first part of a join object between a table in the first part and a table in the second part;
including join columns of the first part in a new data warehouse metadata model represented by the first part plus the join columns;
using an optimization technique to recommend at least one summary table on the new data warehouse metadata model; and
rerouting an incoming query issued against a data warehouse having a table join using at least one summary table derived from the new data warehouse metadata model.

2. The method of claim 1, wherein the table join is selected from a group comprising an outer-join, a cross-join, an inner-join without a referential-integrity constraint, an inner-join with a referential-integrity constraint whose foreign key is null and an inner-join with a referential-integrity constraint whose foreign key is not-null.

3. The method of claim 1, wherein tables of an incoming query and tables of a summary table are divided into:
matched tables;
unmatched tables in the incoming query; and
unmatched tables in the summary table.

4. The method of claim 3, wherein a summary table is considered for query-reroute when:
there is at least one table in the matched tables;
unmatched tables in a summary table definition query form at least one lossless table join with at least one table in the matched tables; and
unmatched tables in the incoming query are joinable with the summary table.

5. The method of claim 1, wherein the first part of the decomposed warehouse model represents a new data warehouse, comprising one or more fact, dimension, and sub-dimension tables having a fact table that joins at least one dimension table, and a dimension table that joins at least one sub-dimension table using an inner-join with a non-null join column and wherein the second part of the decomposed warehouse model represents remaining tables of the decomposed data warehouse.

6. The method of claim 1, wherein rerouting an incoming query issued against a data warehouse having a table join using a new data warehouse metadata model further comprises modeling a join column of the first part into a level object of a new degenerate dimension object, adding the new degenerate dimension object to a cube model object and submitting the new cube model object for recommendation of the summary table.

7. The method of claim 1, wherein the rerouting an incoming query issued against a data warehouse having a table join using a new data warehouse metadata model further comprises recommending at least one summary table on the new data warehouse model to include at least one table column of the new data warehouse that can be used to join at least one table in the second part of the decomposed data warehouse.

8. The method of claim 1, wherein, when the data warehouse comprises a recursive hierarchy:
a bridge table is generated between a fact table of a data warehouse and a dimension table that contains the recursive hierarchy information;
a summary table is recommended that includes at least one special table column to facilitate query-reroute against the bridge table and its associated dimension table; and
the recommended summary table that includes at least one special table column is used to reroute a standard SQL issued against the data warehouse model having the recursive hierarchy.

9. A method for optimizing a data warehouse model involving a recursive hierarchy, comprising:
detecting a recursive hierarchy in a data warehouse model;
generating a bridge table between a fact table of a data warehouse and a dimension table that contains the recursive hierarchy information;
recommending a summary table that includes at least one special table column to facilitate query-reroute against the bridge table and its associated dimension table; and
using the recommended summary table that includes at least one special table column to reroute a standard SQL issued against the data warehouse model having the recursive hierarchy.

10. An apparatus for optimizing a data warehouse having a table join, comprising:
a computer having a data store coupled thereto, wherein the data store stores data for establishing a data warehouse; and
one or more computer programs, performed by the computer, for decomposing a model of the data warehouse into a first part and a second part, identifying join columns on the first part of a join object between a table in the first part and a table in the second part, including join columns of the first part in a new data warehouse metadata model represented by the first part plus the join columns, using an optimization technique to recommend at least one summary table on the new data warehouse metadata model and rerouting an incoming query issued against a data warehouse having a table join using at least one summary table derived from the new data warehouse metadata model.

11. The apparatus of claim 10, wherein the table join is selected from a group comprising an outer-join, a cross-join, an inner-join without a referential-integrity constraint, an inner-join with a referential-integrity constraint whose foreign key is null and an inner-join with a referential-integrity constraint whose foreign key is not-null.

12. The apparatus of claim 10, wherein the computer divides tables of an incoming query and tables of a summary table into:
matched tables,
unmatched tables in the incoming query; and
unmatched tables in the summary table.

13. The apparatus of claim 12, wherein the computer considers a summary table for query-reroute when:
there is at least one table in the matched tables;
unmatched tables in the summary table definition query form at least one lossless table join with at least one table in the matched tables; and
unmatched tables in the incoming query are joinable with the summary table.

14. The apparatus of claim 10, wherein the first part of the decomposed warehouse model represents a new data warehouse, comprising one or more fact, dimension, and sub-dimension tables having a fact table that joins at least one dimension table, and a dimension table that joins at least one sub-dimension table using an inner-join with a non-null join column and wherein the second part of the decomposed warehouse model represents remaining tables of the decomposed data warehouse.

15. The apparatus of claim 10, wherein the computer rerouting an incoming query issued against a data warehouse having a table join using a new data warehouse metadata model by modeling a join column of the first part into a level object of a new degenerate dimension object, adding the new degenerate dimension object to a cube model object and submitting the new cube model object for recommendation of the summary table.

16. The apparatus of claim 10, wherein the computer rerouting an incoming query issued against a data warehouse having a table join using a new data warehouse metadata model by recommending at least one summary table on the new data warehouse model to include at least one table column of the new data warehouse that can be used to join at least one table in the second part of the decomposed data warehouse.

17. The apparatus of claim 10, wherein the computer, when the data warehouse comprises a recursive hierarchy:
generates a bridge table between a fact table of a data warehouse and a dimension table that contains the recursive hierarchy information;
recommends a summary table that includes at least one special table column to facilitate query-reroute against the bridge table and its associated dimension table; and
uses the recommended summary table that includes at least one special table column to reroute a standard SQL issued against the data warehouse model having the recursive hierarchy.

18. A program storage device, comprising:
program instructions executable by a processing device to perform operations for optimizing a data warehouse having a table join, the operations comprising:
decomposing a data warehouse model into a first part and a second part;
identifying join columns on the first part of a join object between a table in the first part and a table in the second part;
including join columns of the first part in a new data warehouse metadata model represented by the first part plus the join columns;
using an optimization technique to recommend at least one summary table on the new data warehouse metadata model; and
rerouting an incoming query issued against the data warehouse having the table join using at least one summary table derived from the new data warehouse metadata model.

19. The program storage device of claim 18, wherein the table join is selected from a group comprising an outer-join, a cross-join, an inner-join without a referential-integrity constraint, an inner-join with a referential-integrity constraint whose foreign key is null and an inner-join with a referential-integrity constraint whose foreign key is not-null.

20. The program storage device of claim 18, wherein tables of an incoming query and tables of a summary table are divided into:
matched tables,
unmatched tables in the incoming query; and
unmatched tables in the summary table.

21. The program storage device of claim 20, wherein a summary table is considered for query-reroute when;
there is at least one table in the matched tables;
unmatched tables in a summary table definition query form at least one lossless table join with at least one table in the matched tables; and
unmatched tables in the incoming query are joinable with the summary table.

22. The program storage device of claim 18, wherein the first part of the decomposed warehouse model represents a new data warehouse, comprising one or more fact, dimension, and sub-dimension tables having a fact table that joins at least one dimension table, and a dimension table that joins at least one sub-dimension table using an inner-join with a non-null join column and wherein the second part of the decomposed warehouse model represents remaining tables of the decomposed data warehouse.

23. The program storage device of claim 18, wherein rerouting an incoming query issued against a data warehouse having a table join using a new data warehouse metadata model further comprises modeling a join column of the first part into a level object of a new degenerate dimension object, adding the new degenerate dimension object to a cube model object and submitting the new cube model object for recommendation of the summary table.

24. The program storage device of claim 18, wherein the rerouting an incoming query issued against a data warehouse having a table join using a new data warehouse metadata model further comprises recommending at least one summary table on the new data warehouse model to include at least one table column of the new data warehouse that can be used to join at least one table in the second part of the decomposed data warehouse.

25. The program storage device of claim 18, wherein, when the data warehouse comprises a recursive hierarchy:
a bridge table is generated between a fact table of a data warehouse and a dimension table that contains the recursive hierarchy information;
a summary table is recommended that includes at least one special table column to facilitate query-reroute against the bridge table and its associated dimension table; and
the recommended summary table that includes at least one special table column is used to reroute a standard SQL issued against the data warehouse model having the recursive hierarchy.

26. An apparatus for optimizing a data warehouse, comprising:
a computer having a data store coupled thereto, wherein the data store stores data for establishing a data warehouse; and
one or more computer programs, performed by the computer, for detecting a recursive hierarchy in a data warehouse model, generating a bridge table between a fact table of a data warehouse and a dimension table that contains the recursive hierarchy information, recommending a summary table that includes at least one special table column to facilitate query-reroute against the bridge table and its associated dimension table and using the recommended summary table that includes at least one special table column to reroute a standard SQL issued against the data warehouse model having the recursive hierarchy.

27. A program storage device, comprising:
program instructions executable by a processing device to perform operations for optimizing a data warehouse model involving a recursive hierarchy, the operations comprising:
detecting a recursive hierarchy in a data warehouse model;
generating a bridge table between a fact table of a data warehouse and a dimension table that contains the recursive hierarchy information;
recommending a summary table that includes at least one special table column to facilitate query-reroute against the bridge table and its associated dimension table; and
using the recommended summary table that includes at least one special table column to reroute a standard SQL issued against the data warehouse model having the recursive hierarchy.
